(19) United States
(12) Patent Application Publication
(10) Pub. No.: US 2008/0141358 A1
(43) Pub. Date: Jun. 12, 2008

(54) IDENTIFICATION AND ADMINISTRATION SYSTEM APPLIED TO PEER-TO-PEER GATEWAY AND METHOD FOR THE SAME

(76) Inventors: Po-Ching LIN, Taipei City (TW); Meng-Fu Tsai, Changhua City (TW); Tsao-Jiang Chang, Taipei City (TW); Ying-Dar Lin, Hsinchu City (TW); Yuan-Cheng Lai, Taipei City (TW)

Correspondence Address: SINORICA, LLC, 528 FALLSGROVE DRIVE, ROCKVILLE, MD, 20850, US

(21) Appl. No.: 11/753,036

(22) Filed: May 24, 2007

(30) Foreign Application Priority Data
Dec. 8, 2006 (TW) 095145974

(51) Int. Cl. G06F 9/00

(52) U.S. Cl. 726/12

(57) ABSTRACT

An identification and administration system applied to P2P gateway and a method for the same are proposed. The system is installed in a kernel space, and a plug-in kernel module is in the kernel space to finish preprocessing and application processing of packets on the kernel space without the need of copying data to the user space for processing. Moreover, a connection cache is provided in the kernel space to process source/destination IP addresses, connection ports and protocol identifiers of all packets to recognize and then block identical request packets in reconnections. Therefore, the throughput of content-level security gateway can be increased, and the processing efficiency of packets can also be enhanced.

### BACKGROUND OF THE INVENTION

1. Field of the Invention

The present invention relates to an administration system of peer-to-peer (P2P) gateway and, more particularly, to an identification and administration system applied to the P2P gateway to enhance the transmission speed and performance of network.

2. Description of Related Art

In recent years, peer-to-peer (P2P) file sharing has grown at an amazing speed in the Internet. How to administrate P2P communication therefore becomes an important issue. System administrators usually utilize well-known connection ports to classify Internet communication, including blocking the communication transmission of specific applications and redirecting to a proxy after several content-level security (e.g., virus scan) operations. However, this classification method is not applicable to the P2P communication because most P2P applications make use of dynamic connection ports, i.e., automatically selecting a connection port instead of using those well-known fixed connection ports. Therefore, P2P applications should be classified based on the features of application-layer messages. Conventionally, the classification procedure is carried out in the kernel space because of its simple signatures in the first several bytes of data. However, administrations such as file filtering and virus scan made to P2P shared files also include the processing of complicated content of data composed of packets. It seems natural that this step should be performed in the user space.

Even though carried out in the user space, P2P administration tools such as InstantScan and P2PADM need to exchange data between the kernel space and the user space. Data exchange (e.g. copying data of the kernel space to the user space), however, will considerably degrade the performance. In fact, this degradation also exists in web server packages such as HTTPd. In order to reduce the degradation, an in-kernel package kHTTPd moves the server HTTPd into the kernel space to directly grasp response messages in the kernel, thereby avoiding data exchange and truly achieving higher performance than the server HTTPd in the user space.

The architecture and administration method of the P2PADM will be described below. The architecture is a novel gateway structure of operation system. The administration objects include (1) connection classification of P2P applications; (2) filtering undesirable P2P applications; (3) performing virus scan for P2P shared files; (4) filtering and auditing chat messages and transferred files; and (5) controlling the bandwidth of P2P traffic. As shown in FIG. 1, a kernel space 10 makes use of an L7-filter 102 to discriminate the connections and store the packets of connection classification into a queue 104. A main thread in a proxy gets packets from the queue 104 in the kernel space 10 after calling a libipq library 122 and performing preprocessing operations such as checksum examining, packet classification and TCP handling in a packet handler 124. Next, the main thread calls threads of a specific application to control operations related to protocols of the application. Each thread of the application is responsible for a specific connection and determines whether to pass or drop a packet in the connection.

The P2PADM uses the libipq library 122 to acquire packets from the queue 104. This libipq library 122 is a library applied to the iptable, and provides an application interface to communicate with an ip_queue kernel module. This ip_queue kernel module makes use of Netfilter functions for registering to transfer packets between the kernel space 10 and a user space 12. Therefore, the P2PADM has to copy data from the kernel space 10 to the user space 12 for the administration of P2P communication. However, copying data will reduce the execution performance of the P2PADM.

Accordingly, the present invention aims to propose an identification and administration system applied to the P2P gateway so as to enhance the performance and effectively conquer the above problems in the prior art.

### SUMMARY OF THE INVENTION

An objective of the present invention is to provide an identification and administration system applied to P2P gateway, in which a plug-in kernel module in the kernel space is provided, and application modules are installed to process protocol, filter and examine so as to facilitate the modification of the protocol of applications.

Another objective of the present invention is to provide an identification and administration system applied to P2P gateway, in which a connection cache is provided to process information such as source/destination IP addresses and source/destination connection ports of packets. A packet having the same information will be determined to be in a reconnection, and the connection cache can thus block this packet.

Yet another objective of the present invention is to provide an identification and administration system applied to P2P gateway, which makes use of a fast pass mechanism to copy out-of-order packets in the gateway and allows the out-of-order packets to quickly pass so as to shorten non-deterministic delay due to packet loss.

To achieve the above objectives, the present invention provides an identification and administration system applied to P2P gateway, which comprises a kernel space installed in an operation system, a kernel module, and a user space. The kernel space comprises a connection cache and an L7-filter. The connection cache receives a plurality of packets and uses the L7-filter to compare features of the packets for classification, and adds an identification mark on the packets of identifiable connection and then performs preprocessing. The plug-in kernel module is in the kernel space, and includes at least an application module responsible for protocol processing, filtering and examining of the packets. Virus scan is performed in the user space.

To achieve the above objectives, the present invention also provides an identification and administration method applied to P2P gateway. The method comprises the steps of a connection cache in a kernel space examining source IP addresses, destination IP addresses, and connection ports of a plurality of packets that enter the connection cache; using an L7-filter to perform connection classification and feature comparison and make an identification mark on the packets of identifiable connection; the kernel space filtering out the packets that are unwanted or performing bandwidth control according to the identification mark and then sending the packets to a packet handler for preprocessing; and using a kernel module to perform protocol processing, filtering and examining of the packets, and the packet handler then sending out the packets.

### BRIEF DESCRIPTION OF THE DRAWINGS

The various objectives and advantages of the present invention will be more readily understood from the following detailed description when read in conjunction with the appended drawing, in which:

FIG. 1 is a diagram of a prior art P2PADM system;

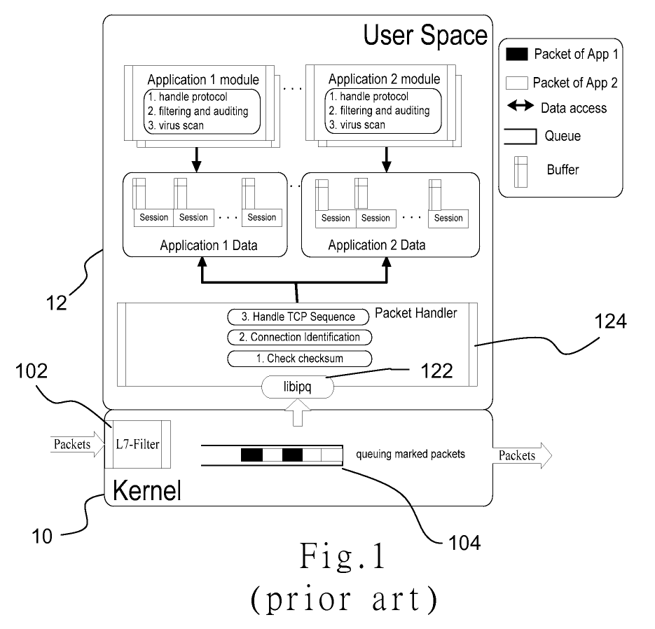

FIG. 2 is a block diagram of an identification and administration system applied to the P2P gateway of the present invention;

FIG. 3 is a packet flow chart in the system of the present invention;

FIG. 4 is a diagram showing the transmission times with and without fast pass mechanism under different packet loss rate;

FIG. 5 is a bar chart showing the throughputs of the system of the present invention and the P2PADM system under different configurations;

FIG. 6 is a bar chart showing the CPU utilization of the system of the present invention and the P2PADM system under different configurations;

FIG. 7 is a bar chart showing the throughput of the system of the present invention with a connection cache; and

FIG. 8 is a bar chart showing the CPU utilization of the system of the present invention with a connection cache.

### DETAILED DESCRIPTION OF THE PREFERRED EMBODIMENTS

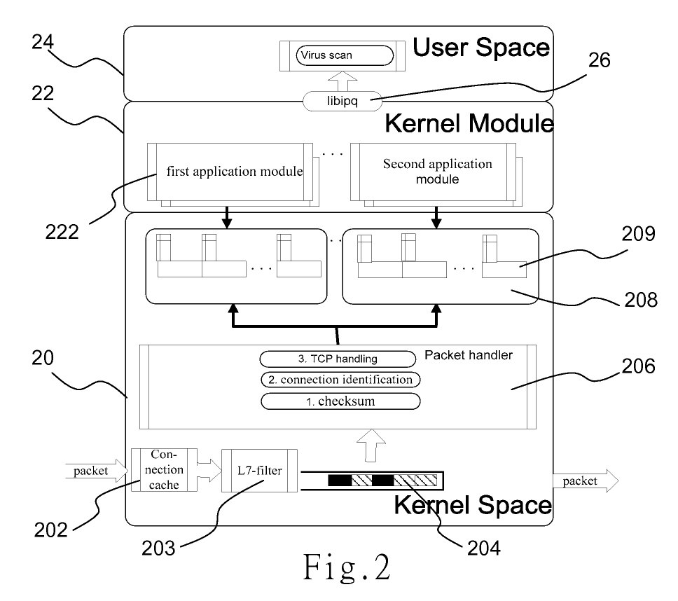

As shown in FIG. 2, the present invention provides an identification and administration system applied to P2P gateway, which comprises a kernel space 20, a kernel module 22, and a user space 24. The kernel space 20 includes a connection cache 202, an L7-filter 203, at least a queue 204, a packet handler 206, and at least an application data 208. The connection cache 202 checks the source/destination IP addresses, the destination connection port and the protocol id. When the connection cache 202 receives a packet having the same above four values, the packet will be considered as a reconnection packet and thus be blocked. The L7-filter 203 compares features of the packets for classification, and makes an identification mark on the packets of identifiable connection. The packets having an identification mark will be stored in the queue 204 in order. The packet handler 206 performs preprocessing of the packets such as checksum examination, connection identification, and TCP handling. In the application data 208, program codes are divided into a plurality of sections to facilitate subsequent processing.

The kernel module 22 includes at least an application module 222 corresponding to the application data 208. The application module 222 is responsible for the verdict of packet such as protocol processing, filtering and examining of packet. Because virus scan of packet will consume much time and may even interrupt the execution of the kernel, the virus scan job is placed in the user space 24. A libipq library 26 is installed on an interface between the kernel module 22 and the user space 24.

In the beginning, all packets enter the connection cache 202, which checks source IP addresses, destination IP addresses, destination connection ports and protocol identifiers of the packets. Next, the L7-filter 203 performs connection classification and feature comparison in the kernel space 20. The L7-filter 203 first collects at most the first eight packets to make up an application message and then performs feature comparison. If the L7-filter 203 can identify all connections of this packet, it makes a predefined identification mark on this packet. The packets having an identification mark are stored in the queue 204. The kernel space 20 will filter out unwanted packets or perform bandwidth control according to the identification mark, and then send the packets to the packet handler 206 for preprocessing. When the preprocessing of packet finishes, specific application modules 222 in the kernel module 22 will be called to perform processing of protocol, filtering and examining of packet.

The system of the present invention may call a scheduling function to transfer the control of the CPU to other processes so as to avoid the situation of starvation. The scheduling function is a Linux kernel function located in schedule.c to schedule processes. If there is no other process wanting to use the CPU, the control of the CPU will be transferred back to the system of the present invention. Moreover, the system of the present invention will call a call_usermodehelper function to invoke virus scan in the user space 24 and block the execution of the Linux kernel until the virus scan job finishes. In order to avoid a long time of blocking, file data will be divided into many pieces for scan. After a piece of data is scanned, the scheduling function will be called to transfer the control of the CPU to the kernel space 20 or other processes.

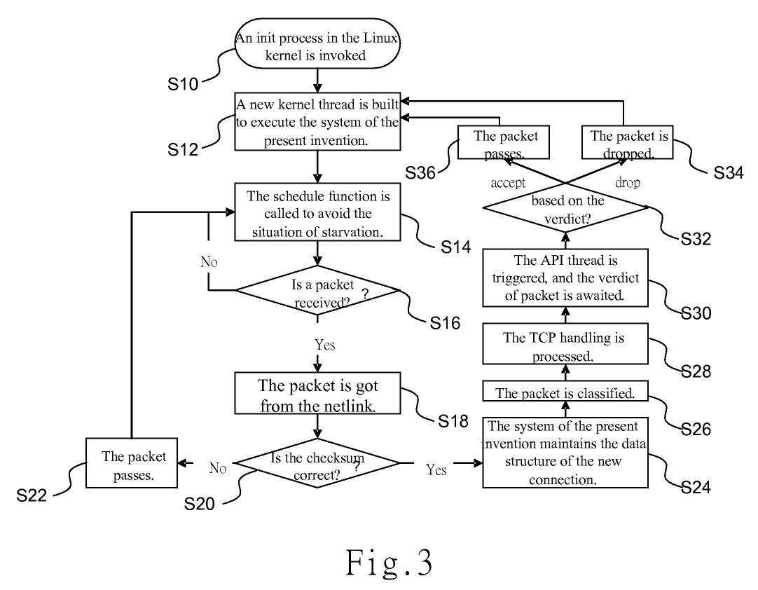

When applying the system of the present invention to the Linux operating system, the packet flow chart is shown in FIG. 3. First, after an init process in the Linux kernel is invoked (Step S10), a new kernel thread is built to execute the system of the present invention (Step S12). This kernel thread will be terminated at shutdown of Linux. The administration architecture in the kernel awaits a new connection, and calls the scheduling function to transfer the control right of the CPU to other processes to avoid the situation of starvation (Step S14). Whether a packet is received is then determined (Step S16). If the answer is yes, the packet is got from the netlink (Step S18), and whether the checksum is correct is determined (Step S20); otherwise, Step S14 is jumped back to for calling the scheduling function again. The netlink is an IP service protocol in the Linux system. When the checksum is incorrect, in order to avoid loss of packet or repetitive sending of acknowledge segment, the packet is allowed to pass quickly (Step S22), and Step S14 is jumped back to for calling the scheduling function again.

When the checksum is correct, a new connection is accepted, and the system of the present invention has to maintain the data structure of the connection socket and use this data structure for I/O operation without relying on any higher-level function (Step S24). Subsequently, preprocessing such as packet classification (Step S26) and TCP handling (Step S28) is performed. After the preprocessing finishes, the system of the present invention notifies a specific application programming interface (API) thread with a signal to process the packet. Next, the API thread will set the verdict of the packet (Step S30) and bases on the verdict (Step S32) to determine whether to drop (Step S34) or accept (Step S36) the packet.

The present invention can effectively process out-of-order packets. The method is to copy these out-of-order packets in the gateway and allow them to pass quickly, as shown in Step S22 of FIG. 3. In this way, the receiving end can receive an intact file earlier. In the prior art, if there is any packet lost, these out-of-order packets will be queued in the gateway, and retransmission may be induced because of TCP timeout, thus lengthening the transmission time. In the present invention, the receiving end will receive these out-of-order packets earlier and sends out three identical ACK segments to the transmitting end to induce retransmission. Because the retransmission is induced by three identical ACK signals instead of TCP timeout, the retransmission can be faster.

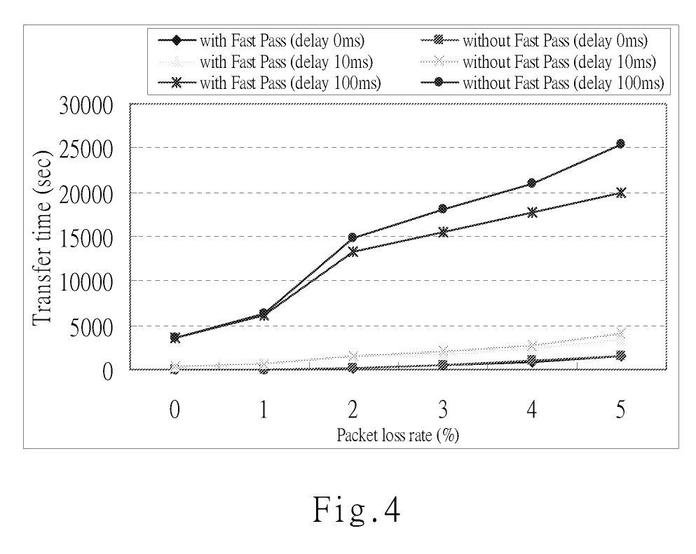

FIG. 4 is a diagram showing the transmission times with and without the fast-pass mechanism under different packet loss percentages. As shown in FIG. 4, the packet loss rate goes from 0% to 5% to emulate actual circumstances. The fast-pass mechanism can reduce the transmission time between the FTP client and the FPT server. Two conclusions can be got from FIG. 4: (1) The higher the packet loss percentage, the larger the difference of the transmission time between systems with and without fast pass; (2) the longer the delay time, the more the transmission time reduced. The reason of the first conclusion is that when the packet loss percentage increases, the queuing time in the gateway increases, making the transmission time larger. The reason of the second conclusion is that when the delay of each packet increases, the queuing time in the gateway increases.

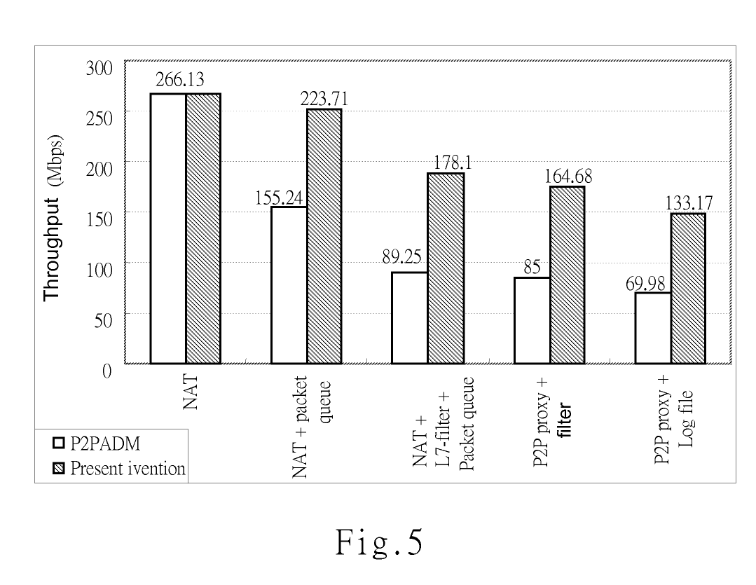

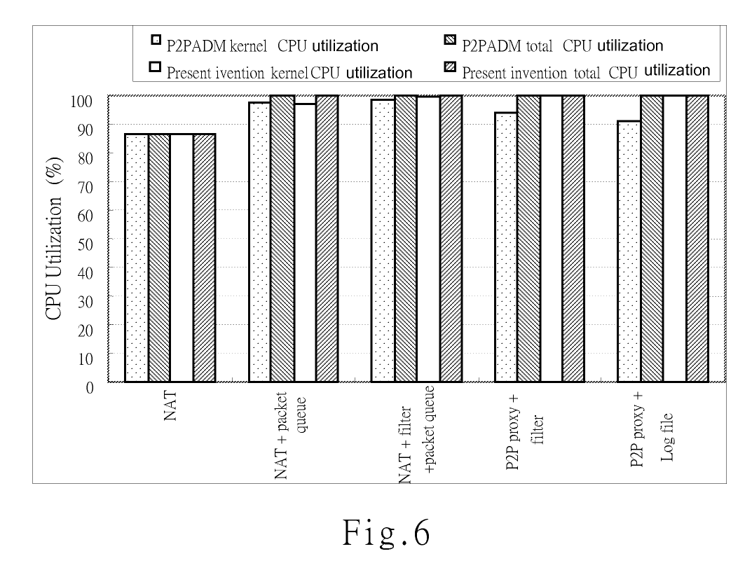

The throughput and the CPU utilization are two primary factors for judging the performance of a gateway system. FIG. 5 is a bar chart showing the throughput of the system of the present invention and the P2PADM system under different configurations. FIG. 6 is a bar chart showing the CPU utilization of the system of the present invention and the P2PADM system under different configurations. FIG. 6 not only provides the CPU utilization of the kernel, but also provides the total CPU utilization of the system. As can be known from the figures, the system of the present invention can transmit faster than the P2PADM system not only because running in the kernel space can reduce the copying of data from the kernel space to the user space, but also because the number of functions to be called can be reduced.

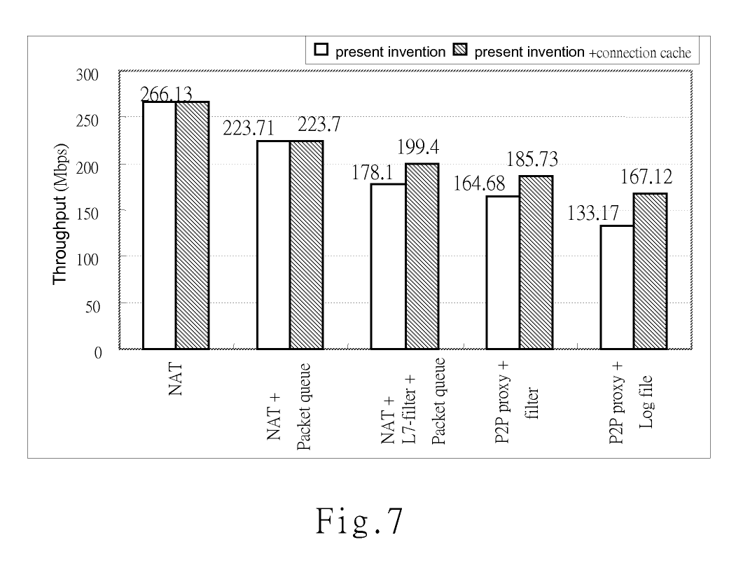

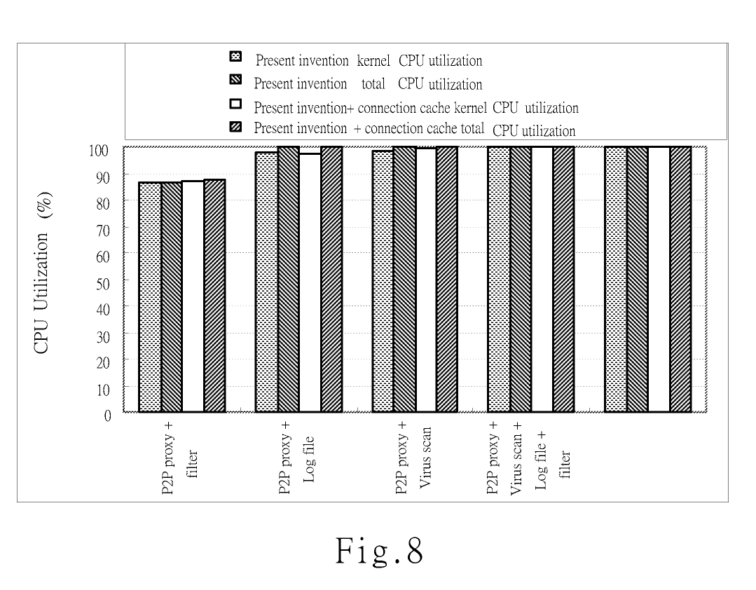

FIG. 7 is a bar chart showing the throughput of the system of the present invention with a connection cache. FIG. 8 is a bar chart showing the CPU utilization of the system of the present invention with a connection cache. In these tests, all packets from one of two clients are blocked to force the blocked client to continually send out requests for retransmission. The connection cache can increase about 15% of the throughput. Because all processing of the system of the present invention is carried out in the kernel space except the virus scan job, the CPU will be occupied by the system of the present invention, and the CPU utilization can always achieve about 100%.

To sum up, the identification and administration system and method applied to P2P gateway can quickly grasp retransmitted packets and block them. When out-of-order packets are generated, they are allowed to pass quickly to avoid non-deterministic delay. Moreover, the preprocessing of packet is moved to the kernel space to reduce transmission actions of data between the kernel space and the user space, thereby accomplishing higher processing performance.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

I claim:

1. An identification and administration system applied to P2P gateway, said system being installed in a virtual memory space of an operating system, said identification and administration system comprising:
a kernel space including a connection cache and an L7-filter, said connection cache receiving a plurality of packets and using said L7-filter to compare features of said packets for classification and adding an identification mark on said packets of identifiable connection and then performing preprocessing;
a plug-in kernel module in said kernel space, said kernel module including at least an application module responsible for protocol processing, filtering and examining of said packets; and
a user space for performing virus scan.

2. The system as claimed in claim 1, wherein said connection cache is empty before said packets enter said connection cache after said system is booted so that all said packets enter said connection cache.

3. The system as claimed in claim 1, wherein said connection cache checks source IP addresses, destination IP addresses, connection ports, and protocol identifiers of said packets.

4. The system as claimed in claim 1, wherein said connection cache updates connection information.

5. The system as claimed in claim 1, wherein said kernel space filters out said packets that are unwanted or perform bandwidth control according to said identification mark.

6. The system as claimed in claim 1, wherein said L7-filter collects at most first eight of said packets to make up an application message and then performs feature comparison.

7. The system as claimed in claim 1 further comprising a packet handler, wherein said packet handler performs preprocessing actions including examining checksum of said packets, connection identification, and TCP handling.

8. The system as claimed in claim 7 further comprising at least a queue, wherein said packets having said identification mark are stored in said queue and then sent out to said packet handler in order.

9. The system as claimed in claim 1, wherein the actions of said kernel space and said kernel module stop when performing virus scan in said user space.

10. The system as claimed in claim 1 further comprising a schedule function for process scheduling, wherein said schedule function is called to transfer control right of a CPU to other processes.

11. The system as claimed in claim 1, wherein said connection cache determines whether to accept or drop said packets.

12. The system as claimed in claim 1, wherein said connection cache filters out retransmission to enhance system performance.

13. An identification and administration method applied to P2P gateway comprising the steps of:
a connection cache in a kernel space examining source IP addresses, destination IP addresses, connection ports, and protocol identifiers of a plurality of packets that enter said connection cache;
using an L7-filter to perform connection classification and feature comparison and make an identification mark on said packets of identifiable connection;
said kernel space filtering out said packets that are unwanted or performing bandwidth control according to said identification mark and then sending said packets to a packet handler for preprocessing; and
using a kernel module to perform protocol processing, filtering and examining of said packets, and said packet handler then sending out said packets.

14. The method as claimed in claim 13, wherein said connection cache is empty before said packets enter said connection cache after said system is booted so that all said packets enter said connection cache.

15. The method as claimed in claim 13, wherein said connection cache updates connection information.

16. The method as claimed in claim 13, wherein said L7-filter collects at most first eight of said packets to make up an application message and then performs feature comparison.

17. The method as claimed in claim 13, wherein said packet handler performs preprocessing actions including examining checksum of said packets, connection identification, and TCP handling.

18. The method as claimed in claim 13, wherein said L7-filter stores said packets having said identification mark in a queue and then sends out said packets to said packet handler in order.

19. The method as claimed in claim 13, wherein virus scan actions of said packets are performed in a user space.

20. The method as claimed in claim 19, wherein the actions of said kernel space and said kernel module stop when performing virus scan in said user space.

21. The method as claimed in claim 13 further comprising a schedule function for process scheduling, wherein said schedule function is called to transfer control right of a CPU to other processes.

22. The method as claimed in claim 13, wherein said kernel module is a plug-in in said kernel space.
